(19) United States
(12) Patent Application Publication
(10) Pub. No.: US 2026/0175701 A1
(43) Pub. Date: Jun. 25, 2026

(54) VEHICLE CONTROL SYSTEM

(71) Applicant: TOYOTA JIDOSHA KABUSHIKI KAISHA, Toyota-shi (JP)

(72) Inventor: Hideo ASAI, Gotenba-shi (JP)

(73) Assignee: TOYOTA JIDOSHA KABUSHIKI KAISHA, Toyota-shi (JP)

(21) Appl. No.: 19/305,012

(22) Filed: Aug. 20, 2025

(30) Foreign Application Priority Data
Dec. 24, 2024 (JP) 2024-228038

(51) Int. Cl. B60L 15/20

(52) U.S. Cl. CPC B60L 15/20; B60L 2240/12; B60L 2240/42; B60L 2250/26; B60L 2260/20

(57) ABSTRACT

The vehicle control system is applied to a vehicle including an electric motor as a drive source. The vehicle control system executes a virtual mobility simulation process for simulating virtual mobility in the vehicle. In the sensation amplification mode, the vehicle control system acquires an operation input value corresponding to a driving operation by a driver of the vehicle. The vehicle control system sets an amplified operation input value larger than the operation input value based on the operation input value. The vehicle control system calculates amplified vehicle parameters for virtual mobility simulation processing by inputting amplified operation input values to a model of virtual mobility. The vehicle control system executes a virtual mobility simulation process based on the amplified vehicle parameters.

### CROSS-REFERENCE TO RELATED APPLICATION

This application claims priority to Japanese Patent Application No. 2024-228038 filed on Dec. 24, 2024. The disclosure of the above-identified application, including the specification, drawings, and claims, is incorporated by reference herein in its entirety.

### BACKGROUND

### 1. Technical Field

The present disclosure relates to a technique of simulating virtual mobility in a vehicle including an electric motor as a drive source.

### 2. Description of Related Art

Japanese Patent No. 7,298,566 discloses a battery electric vehicle that simulates manual shifting operation of a manual transmission (MT) vehicle.

### SUMMARY

A vehicle equipped with a simulation mode for simulating virtual mobility is considered. It is conceivable that a user of the vehicle does not easily feel that the virtual mobility is being simulated even during the simulation mode, depending on the traveling situation of the vehicle. There is a need for the user of the vehicle to experience simulation of the virtual mobility even in such a traveling situation.

One aspect of the present disclosure relates to a vehicle control system. The vehicle control system is to be applied to a vehicle including an electric motor as a drive source.

The vehicle control system includes one or more processors configured to execute a virtual mobility simulation process of simulating virtual mobility in the vehicle.

The one or more processors are configured to, in a sensation amplification mode, acquire an operation input value corresponding to a driving operation by a driver of the vehicle.

The one or more processors set an amplified operation input value based on the operation input value, the amplified operation input value being larger than the operation input value.

The one or more processors calculate an amplified vehicle parameter for the virtual mobility simulation process by inputting the amplified operation input value to a model of the virtual mobility.

The one or more processors execute the virtual mobility simulation process based on the amplified vehicle parameter.

According to the present disclosure, the vehicle control system is equipped with a “sensation amplification mode”. In the sensation amplification mode, an amplified operation input value that is larger than an operation input value corresponding to a driving operation by the user is set. An amplified vehicle parameter is calculated by inputting the amplified operation input value to a virtual mobility model, and a virtual mobility simulation process is executed based on the amplified vehicle parameter. As a result, the user is more likely to feel that the virtual mobility is simulated in the sensation amplification mode than in a normal mode.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a vehicle and a vehicle control system;

FIG. 2 is a block diagram for explaining a basic vehicle control process;

FIG. 3 is a diagram illustrating an example of a virtual vehicle model;

FIG. 4 is a diagram illustrating torque characteristics of an electric motor in a virtual mode;

FIG. 5 is a block-diagram for explaining a sensation amplification mode; and

FIG. 6 is a conceptual diagram for explaining a modification.

### DETAILED DESCRIPTION OF EMBODIMENTS

### 1. Vehicle and Vehicle Control System

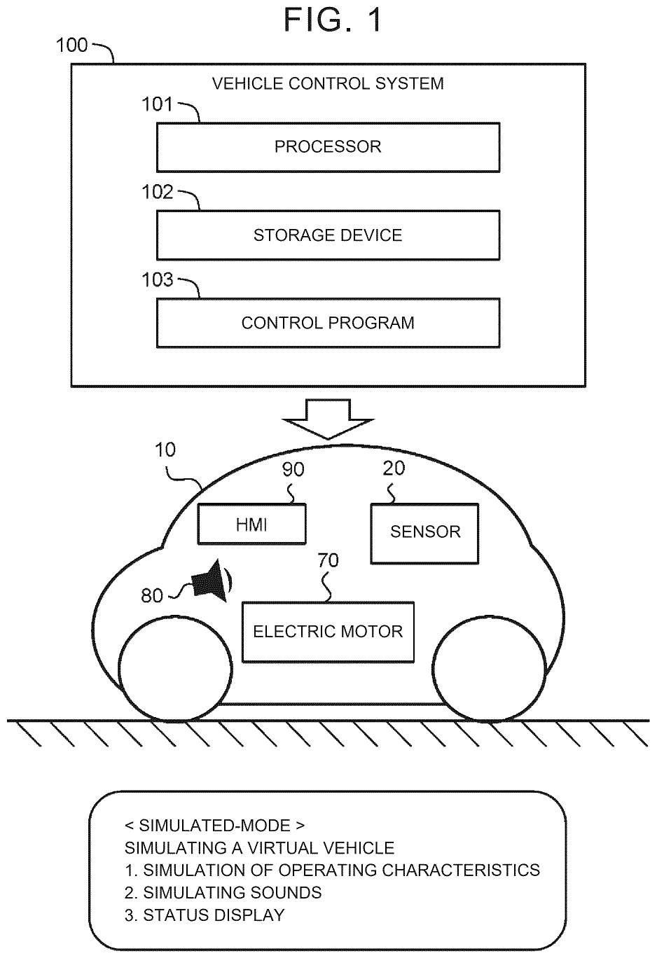

FIG. 1 is a conceptual diagram illustrating a vehicle 10 and a vehicle control system 100 according to the present embodiment. For example, the vehicles 10 are battery electric vehicle that use the electric motor 70 as a driving source for traveling. For example, the vehicles 10 are battery electric vehicle (BEV: Battery Electric Vehicle). Alternatively, the vehicles 10 may be hybrid electric vehicle (HEV), plug-in hybrid electric vehicle (PHEV), fuel cell electric vehicle (FCEV), etc.

The vehicle 10 includes various sensors 20 for detecting a driving state of the vehicle 10. Examples of the various sensors 20 include an accelerator position sensor, a brake position sensor, a steering angle sensor, a steering torque sensor, a wheel speed sensor, an acceleration sensor, and a rotation speed sensor. The accelerator position sensor detects an operation amount of the accelerator pedal. The brake position sensor detects an operation amount of the brake pedal. The rotational speed sensor detects the rotational speed of the electric motor 70.

Further, the vehicle 10 is equipped with one or a plurality of speakers 80. For example, the speaker 80 is an in-vehicle speaker. As another example, the speaker 80 may be an out-of-vehicle speaker. The vehicle 10 may include both an in-vehicle speaker and an out-vehicle speaker.

Further, the vehicles 10 are equipped with HMI (Human Machine Interface) 90. HMI 90 includes an inputting device and a displaying device. Examples of the input device include a touch panel, a switch, and a button. Examples of the display device include a display, a touch panel, a meter, and an instrument.

The vehicle control system 100 is applied to the vehicle 10 and controls the vehicle 10. The entire vehicle control system 100 may be mounted on the vehicle 10. As another example, at least a portion of the vehicle control system 100 may be included in a management server external to the vehicle 10. In that case, the vehicle control system 100 may remotely control the vehicle 10. As yet another example, the vehicle control system 100 may be distributed between the vehicle 10 and the management server.

Generally speaking, vehicle control system 100 includes one or more processors 101 (hereinafter simply referred to as processors 101) and one or more storage devices 102 (hereinafter simply referred to as storage devices 102). The processor 101 executes various processes. Exemplary processors 101 include general purpose processors, special purpose processors, CPU, GPU, ASIC, FPGA, etc. The processor 101 may also be referred to as a circuitry or a processing circuitry. The storage device 102 stores various types of information. Examples of the storage device 102 include a volatile memory, a nonvolatile memory, and a HDD, SSD. The functions of the vehicle control system 100 are realized by the cooperation of the processor 101 and the storage device 102.

One or more control programs 103 (hereinafter simply referred to as control programs 103) are computer programs executed by the processor 101. The functions of the vehicle control system 100 may be realized by cooperation of the processor 101 executing the control program 103 and the storage device 102. The control program 103 is stored in the storage device 102. Alternatively, the control program 103 may be recorded in a computer-readable recording medium.

The vehicle control system 100 according to the present embodiment includes a “simulated mode” as one of the operation modes. The simulation mode is a mode in which virtual mobility is simulated (reproduced) in the vehicle 10. For example, the virtual mobility to be simulated is a different type of vehicle from the vehicle 10. The virtual mobility may be another battery electric vehicle or may be a manual transmission vehicle (MT vehicle). As another example, the virtual mobility to be simulated may be a train, an airplane, or the like. The process of simulating virtual mobility in the vehicle 10 is hereinafter referred to as “virtual mobility simulation process”.

The virtual mobility simulation process may include a “first simulation process”of controlling the electric motor 70 to simulate the operating characteristics of the virtual mobility. The operating characteristic includes, for example, a driving force. When the virtual mobility is MT, the driving characteristic may be a driving force considering a virtual gear stage. The vehicle control system 100 calculates the driving force of the virtual mobility, and controls the electric motor 70 so that the driving force is realized.

The virtual mobility simulation process may include a “second simulation process” of providing the driving environment information of the virtual mobility to the user of the vehicle 10. Typically, the user includes a driver. The user may include an occupant other than the driver.

One example of the operation environment information in the second simulation process is “sound” of virtual mobility. Typically, the simulated (reproduced) sound is a driving sound or a traveling sound of virtual mobility. When the virtual mobility is an engine vehicle, the engine sound may be simulated. The vehicle control system 100 generates a simulated sound simulating a sound of virtual mobility, and outputs the simulated sound from the speaker 80. In other words, the vehicle control system 100 provides the simulated sound (driving environment information) to the user through the speaker 80.

Another example of the operation environment information in the second simulation process is state information of virtual mobility. For example, when the virtual mobility is an engine vehicle, the status information may include a virtual engine rotational speed Ne. The virtual engine rotational speed Ne is a rotational speed of the virtual engine when the vehicle 10 is assumed to be driven by the virtual engine. The vehicle control system 100 calculates the virtual engine rotational speed Ne and displays the virtual engine rotational speed Ne on a HMI 90 display device. In other words, the vehicle control system 100 provides the state information (driving environment information) to the user through HMI 90.

The simulated mode described above allows the user of the vehicle 10 to experience virtual mobility. For example, the driver of the vehicle 10 may feel as if he is driving virtual mobility. It is also possible to switch the simulated virtual mobility. Specifically, the user of the vehicle 10 uses HMI 90 to designate a desired virtual mobility from among a plurality of types of virtual mobility. The vehicle control system 100 simulates virtual mobility specified by a user. As a result, the user of the vehicle 10 can experience his or her favorite virtual mobility.

### 2. Basic Vehicle Control Process

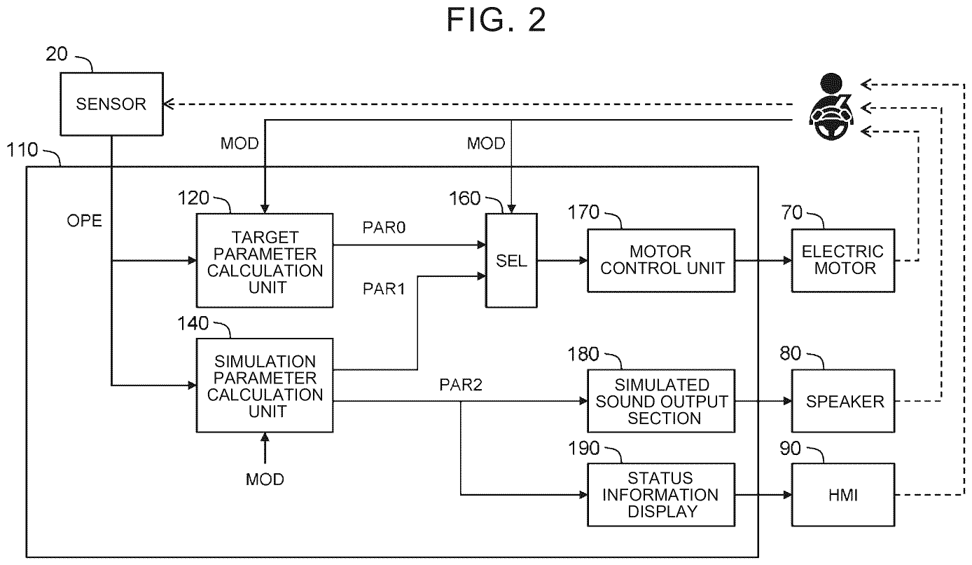

FIG. 2 is a block diagram for explaining a basic vehicle control process performed by the vehicle control system 100. The vehicle control system 100 includes a vehicle control unit 110. The vehicle control unit 110 is realized by cooperation of the processor 101 and the storage device 102. The vehicle control unit 110 includes a target parameter calculation unit 120, a simulation parameter calculation unit 140, a selector 160, a motor control unit 170, a simulated sound output unit 180, and a state information display unit 190.

The vehicle control unit 110 acquires the operation input value OPE corresponding to the driving operation performed by the driver of the vehicle 10. The operation input value OPE reflects a driving operation performed by a driver of the vehicle 10, and is obtained by the sensor 20 mounted on the vehicle 10. For example, the operation input value OPE includes an accelerator operation amount Pap. The accelerator operation amount Pap is an operation amount of an accelerator pedal of the vehicle 10 operated by the driver. The accelerator operation amount Pap is detected by an accelerator position sensor. As another example, the operation input value OPE may include a vehicle speed (wheel speed) V. The vehicle speed (wheel speed) V is detected by a wheel speed sensor.

Further, a mode designation information MOD for designating an operation mode is inputted to the vehicle control unit 110. The operation mode is broadly divided into two types: “EV mode” and “simulated mode”. In EV mode, the vehicle control unit 110 normally controls the vehicle 10. On the other hand, in the simulation mode, the vehicle control unit 110 simulates virtual mobility in the vehicle 10. The user of the vehicle 10 can specify the operation mode by using HMI 90 inputting device. The mode designation information MOD indicates an operation mode designated by the user.

### 2-1. EV

In EV, the target parameter calculation unit 120 calculates a target parameter PAR0 for controlling the vehicles 10. More specifically, the target parameter calculation unit 120 calculates the target parameter PAR0 based on the operation input value OPE corresponding to the driving operation performed by the drivers. For example, the target parameter PAR0 includes a drive wheel torque Tw. The target parameter PAR0 may include a required motor torque Tm required to realize the drive wheel torque Tw.

In EV mode, the selector 160 (arbitration unit) selects the target parameter PAR0 calculated by the target parameter calculation unit 120, and outputs the target parameter PAR0 to the motor control unit 170.

The motor control unit 170 controls the electric motor 70 in accordance with the target parameter PAR0. For example, the motor control unit 170 calculates a required motor torque Tm required to realize the drive wheel torque Tw included in the target parameter PAR0. In order to convert the drive wheel torque Tw into the required motor torque Tm, the reduction ratio from the output shaft of the electric motor 70 to the drive wheels is used. Then, the motor control unit 170 controls the inverters in accordance with the required motor torque Tm to control the electric motor 70.

### 2-2. Simulated Mode

In the simulation mode, the vehicle control unit 110 executes a virtual mobility simulation process for simulating virtual mobility. First, the simulation parameter calculation unit 140 calculates a vehicle parameter for the virtual mobility simulation process based on the operation input value OPE corresponding to the driving operation by the drivers. More specifically, the simulation parameter calculation unit 140 includes a virtual mobility model MDL that is a model of virtual mobility to be simulated. The simulation parameter calculation unit 140 calculates a vehicle parameter for the virtual mobility simulation process by inputting the operation input value OPE to the virtual mobility model MDL.

As an example, a description will be given of a case where the virtual mobility to be simulated is a manual transmission (MT) vehicle. The vehicle 10 includes a pseudo shifter. The pseudo-shifter may be a pseudo-paddle shifter or a pseudo-shift lever. The drivers can specify the virtual gear stage GP by operating the pseudo-shifter. When the pseudo shifter is a pseudo shift lever, the vehicle 10 may include a pseudo clutch pedal simulating a clutch pedal. The driver depresses the pseudo clutch pedal when it is desired to change the virtual gear stage GP, and returns the pseudo clutch pedal when the virtual gear stage GP is changed. The sensor 20 may include a clutch position sensor for detecting a depression amount of the pseudo clutch pedal 28. The operation input value OPE inputted to the vehicle control unit 110 includes an accelerator operation amount Pap, a vehicle speed (wheel speed) V, a virtual gear stage GP, and a virtual clutch operation amount Pc.

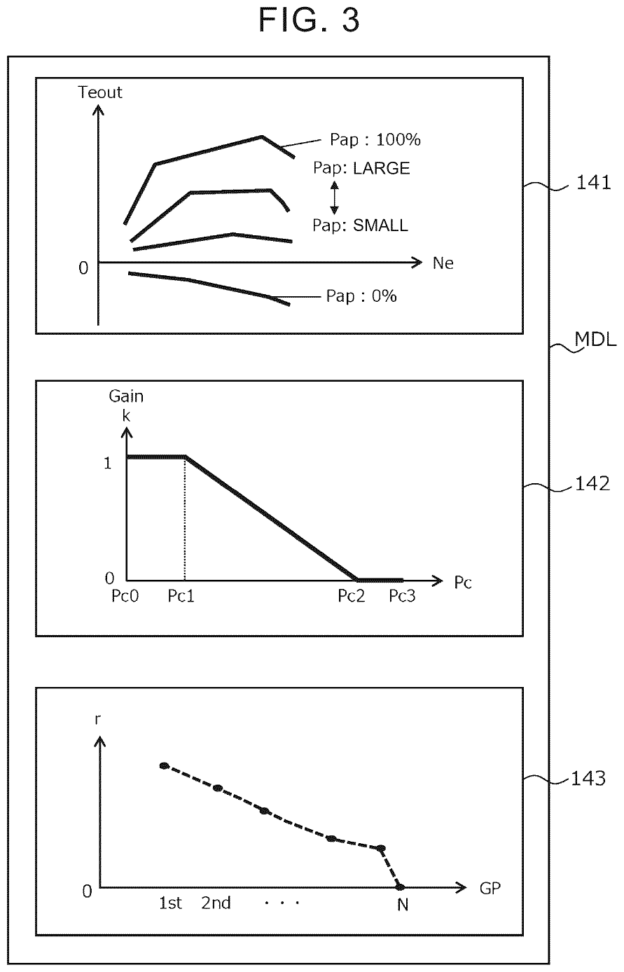

FIG. 3 illustrates an exemplary virtual vehicle model (virtual mobility model MDL) that is a model of a MT vehicle that is a simulation target. The virtual vehicle model includes an engine model 141, a clutch model 142, and a transmission model 143. The engine, the clutch, and the transmission virtually realized by the virtual vehicle model are referred to as a virtual engine, a virtual clutch, and a virtual transmission, respectively.

The engine model 141 calculates a virtual engine rotational speed Ne and a virtual engine power torque Teout. The virtual engine rotational speed Ne is a rotational speed of the virtual engine when the vehicle 10 is assumed to be driven by the virtual engine. For example, the virtual engine rotational speed Ne is calculated based on the wheel speed V, the overall reduction ratio R, and the slip-rate Rslip of the virtual clutch. For example, the virtual engine rotational speed Ne is expressed by the following equation (1).

$$Ne = V \times R / ( 1 - Rslip ) \qquad Expression ( 1 )$$

The virtual engine output torque Teout is calculated from the virtual engine rotational speed Ne and the accelerator operation amount Pap. In calculating the virtual engine output torque Teout, as shown in FIG. 3, a map that defines the relation between the accelerator operation amount Pap, the virtual engine rotational speed Ne, and the virtual engine output torque Teout is used. In this map, a virtual engine output torque Teout with respect to the virtual engine rotational speed Ne is given for each accelerator operation amount Pap.

The clutch model 142 calculates a torque transmission gain k. The torque transmission gain k is a gain for calculating a torque transmission degree of the virtual clutch according to the virtual clutch operation amount Pc. The virtual clutch operation amount Pc is usually 0%, and is temporarily opened to 100% in conjunction with the switching of the virtual gear stage. The clutch model 142 has a map as shown in FIG. 3. In this map, the torque transmission gain k is given to the virtual clutch operation amount Pc. Pc0 corresponds to a position where the virtual clutch operation amount Pc is 0%, and Pc3 corresponds to a position where the virtual clutch operation amount Pc is 100%. The range from Pc0 to Pc1 and the range from Pc2 to Pc3 are dead zones. The clutch model 142 calculates the clutch output torque Tcout using the torque transmission gain k. For example, the clutch output torque Tcout is given by the product of the virtual engine output torque Teout and the torque transfer gain k (Tcout=Teout×k).

In addition, the clutch model 142 calculates the slip-rate Rslip. The slip-rate Rslip is used to calculate the virtual engine rotational speed Ne in the engine model 141. The slip ratio Rslip can be calculated using a map in which the slip ratio Rslip is given to the virtual clutch operation amount Pc in the same manner as the torque transmission gain k.

The transmission model 143 calculates a gear ratio r. The gear ratio r is a gear ratio determined by the virtual gear stage GP in the virtual transmission. The transmission model 143 has a map as shown in FIG. 3. In this map, the larger the virtual gear stage GP, the smaller the gear ratio r. The transmission model 143 calculates the transmission output torque Tgout using the gear ratio r and the clutch output torque Tcout. For example, the transmission output torque Tgout is given by the product of the clutch output torque Tcout and the gear ratio r (Tgout=Tcout×r). The transmission output-torque Tgout changes discontinuously in response to the change of the gear ratio r. This discontinuous change in the transmission output-torque Tgout causes a shift-shock, which results in the appearance of a vehicle equipped with a stepped transmission.

The drive wheel torque Tw is calculated using a predetermined reduction ratio rr. The reduction ratio rr is a fixed value determined by the mechanical structure from the virtual transmission to the drive wheels. The total reduction ratio R is obtained by multiplying the reduction ratio rr by the gear ratio r. In the virtual vehicle model, the drive wheel torque Tw is calculated from the transmission output torque Tgout and the reduction ratio rr. For example, the drive wheel torque Tw is given by the product of the transmission power torque Tgout and the reduction ratio rr (Tw=Tgout×rr).

As described above, the simulation parameter calculation unit 140 calculates the vehicle parameters such as the virtual engine output torque Teout, the drive wheel torque Tw, the virtual engine rotational speed Ne, and the like by inputting the operation input value OPE to the virtual mobility model MDL. Then, the virtual mobility simulation process is executed based on the calculated vehicle parameters.

Note that the virtual mobility that is the simulation target may be switchable. Here, a virtual mobility model MDL for each of a plurality of types of virtual mobility is prepared. The simulation parameter calculation unit 140 selects and uses the virtual mobility model MDL related to the virtual mobility specified by the user.

### 2-2-1. First Simulation Process

The virtual mobility simulation process includes a “first simulation process” of controlling the electric motor 70 to simulate the operating characteristics of the virtual mobility. The vehicle parameter for the first simulation process is hereinafter referred to as “first vehicle parameter PAR1”. For example, the first vehicle parameter PAR1 includes the drive wheel torque Tw calculated by the simulation parameter calculation unit 140. The first vehicle parameter PAR1 may include a required motor torque Tm required to realize the drive wheel torque Tw.

In the simulation mode, the selector 160 (arbitration unit) selects the first vehicle parameter PAR1 calculated by the simulation parameter calculation unit 140, and outputs the first vehicle parameter PAR1 to the motor control unit 170.

The motor control unit 170 controls the electric motor 70 in accordance with the first vehicle parameter PAR1. For example, the motor control unit 170 calculates a required motor torque Tm required to realize the drive wheel torque Tw included in the first vehicle parameter PAR1. Then, the motor control unit 170 controls the inverters in accordance with the required motor torque Tm to control the electric motor 70.

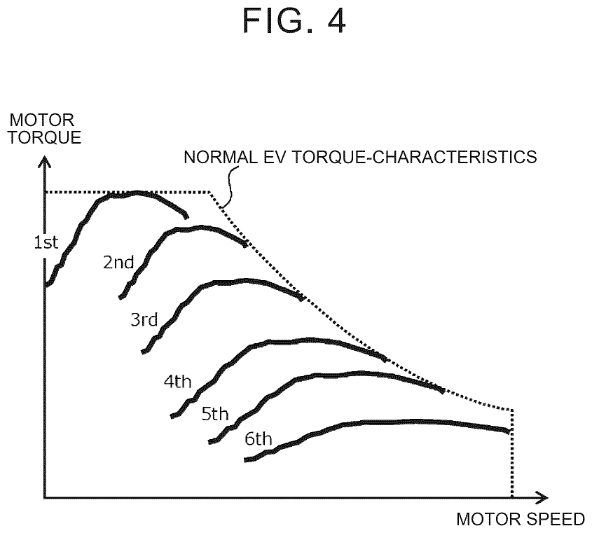

FIG. 4 is a diagram showing torque characteristics of the electric motor 70 in the simulated mode compared with torque characteristics of the electric motor 70 in EV mode. In the embodiment shown in FIG. 4, the virtual mobility is MT vehicles. As shown in FIG. 4, in the simulated mode, a torque characteristic (solid line in the figure) that simulates the torque characteristic of MT vehicles can be realized. In FIG. 4, the number of gear stages is six.

### 2-2-2. Second Simulation Process

The virtual mobility simulation process includes a “second simulation process”of providing the driving environment information of the virtual mobility to the user of the vehicle 10. The vehicle parameter for the second simulation process is hereinafter referred to as “second vehicle parameter PAR2”. For example, the second vehicle parameter PAR2 includes the virtual engine rotational speed Ne calculated by the simulation parameter calculation unit 140. The second vehicle parameter PAR2 may include the virtual engine-output-torque Teout calculated by the simulation parameter calculation unit 140.

The driving environment information may include a “sound” of virtual mobility. The simulated sound output unit 180 generates a simulated sound of virtual mobility according to the second vehicle parameter PAR2. For example, when the virtual mobility is a MT vehicle, the simulated sound is a simulated engine sound. For example, the frequency of the pseudo-engine sound changes in proportion to the virtual engine rotational speed Ne. In addition, the sound pressure of the pseudo-engine sound may be changed in proportion to the virtual engine output-torque Teout. The simulated sound output unit 180 outputs the generated simulated sound from the speaker 80. That is, the simulated sound output unit 180 provides the simulated sound (driving environment information) corresponding to the second vehicle parameter PAR2 to the user through the speaker 80.

The driving environment information may include state information of virtual mobility. For example, when the virtual mobility is a MT vehicle, the status information may include a virtual engine rotational speed Ne. The virtual engine rotational speed Ne is included in the second vehicle parameter PAR2. The status information display unit 190 displays the information of the virtual engine rotational speed Ne on the display device of HMI 90. That is, the state information display unit 190 provides the state information (driving environment information) corresponding to the second vehicle parameter PAR2 to the user through HMI 90.

### 3. Sensation Amplification Mode

Even during the simulation mode, it is conceivable that the user of the vehicle 10 hardly feels that the virtual mobility is being simulated depending on the traveling state of the vehicle 10. For example, while virtual mobility is simulated during low-speed and low-load driving, this may be difficult to convey to a user of a vehicle. Even in such a traveling situation, there is a need for a user of a vehicle to experience simulations of virtual mobility.

In addition, despite the use of computer resources for simulating virtual mobility, it is not preferable from the viewpoint of effective use of computer resources that the user's experience is not so great. From the viewpoint of effective use of computer resources, it is desired that the user can easily experience simulations of virtual mobility.

Therefore, in the present embodiment, as the simulated mode, a “sensation amplification mode” is also prepared separately from the normal simulated mode. The experience amplification mode is a mode for making simulations of virtual mobility easier to experience than in the case of the normal simulation mode. The user can select either the “normal simulated mode” or the “sensory amplifying mode” by using HMI 90 inputting device. The mode designation information MOD indicates an operation mode designated by the user.

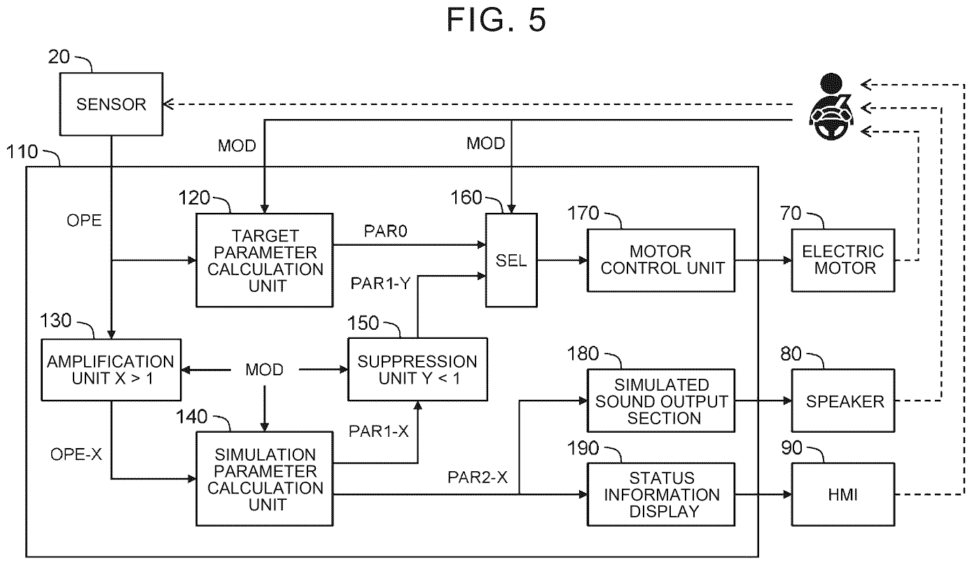

FIG. 5 is a block diagram for explaining the sensation amplification mode. The description that overlaps with FIG. 2 described above is omitted as appropriate. The vehicle control unit 110 further includes an amplification unit 130.

The amplification unit 130 acquires the operation input value OPE corresponding to the driving operation performed by the driver. The amplification unit 130 sets an amplified operation input value OPE-X larger than the operation input value OPE based on the operation input value OPE. For example, the amplification unit 130 calculates the amplified operation input value OPE-X by multiplying the operation input value OPE by the correction coefficient X. Here, the correction coefficient X is a real number larger than 1 (X>1). For example, when the operation input value OPE includes the accelerator operation amount Pap, the accelerator operation amount Pap in the amplified operation input value OPE-X is X times the original value. As another example, when the operation input value OPE includes the vehicle speed V, the vehicle speed V in the amplified operation input value OPE-X is X times the original speed. The correction coefficient X applied to each of the accelerator operation amount Pap and the vehicle speed V may be the same or different from each other.

In the normal simulation mode, the amplification unit 130 outputs the operation input value OPE as it is. This is equivalent to the case where the correction coefficient X=1.

In the sensation amplification mode, the simulation parameter calculation unit 140 calculates the amplified vehicle parameter based on the amplified operation input value OPE-X instead of the operation input value OPE. More specifically, the simulation parameter calculation unit 140 calculates the amplified vehicle parameter by inputting the amplified operation input value OPE-X to the virtual mobility model MDL. The virtual mobility model MDL is the same as in the normal simulated mode. When considering the same operation input value OPE, the amplified vehicle parameters obtained in the sensation amplification mode are larger than the vehicle parameters obtained in the normal simulated mode. Then, a virtual mobility simulation process is executed based on the amplified vehicle parameters. Therefore, in the sensation amplification mode, the user is more likely to experience that the virtual mobility is simulated than in the normal simulation mode.

The first vehicle parameter PAR1 calculated in the sensation amplification mode is hereinafter referred to as “first amplified vehicle parameter PAR1-X”. When considering the same operation input value OPE, the first amplified vehicle parameter PAR1-X obtained in the sensation amplification mode is larger than the first vehicle parameter PAR1 obtained in the normal simulation mode. For example, the first amplified vehicle parameter PAR1-X includes a drive wheel torque Tw. Since the accelerator operation amount Pap is larger than that in the normal simulation mode, the drive wheel torque Tw is also larger than that in the normal simulation mode.

The second vehicle parameter PAR2 calculated in the sensation amplification mode is hereinafter referred to as “second amplified vehicle parameter PAR2-X”. When considering the same operation input value OPE, the second amplified vehicle parameter PAR2-X obtained in the sensation amplification mode is larger than the second vehicle parameter PAR2 obtained in the normal simulation mode. For example, the second amplified vehicle parameter PAR2-X may include a virtual engine rotational speed Ne. Since the vehicle speed V is larger than that in the normal simulation mode, the virtual engine rotational speed Ne is also larger than that in the normal simulation mode. The second amplified vehicle parameter PAR2-X may include a virtual engine-output-torque Teout. Since the accelerator operation amount Pap is larger than that in the normal simulation mode, the virtual engine output torque Teout is also larger than that in the normal simulation mode.

The simulated sound output unit 180 generates a simulated sound of virtual mobility in accordance with the second amplified vehicle parameter PAR2-X. Since the second amplified vehicle parameter PAR2-X is larger than the second vehicle parameter PAR2 in the normal simulation mode, the frequency and sound pressure of the simulated sound of the virtual mobility are larger than those in the normal simulation mode. This makes it easier for the user of the vehicle 10 to experience simulated virtual mobility.

The state information display unit 190 displays the state information corresponding to the second amplified vehicle parameter PAR2-X on the display device of HMI 90. For example, the status information may include a virtual engine rotational speed Ne. The virtual engine rotational speed Ne is higher than in the normal simulated mode. This makes it easier for the user of the vehicle 10 to experience simulated virtual mobility.

As described above, in the sensation amplification mode, the vehicle control unit 110 performs the second simulation process based on the second amplified vehicle parameter PAR2-X. More specifically, the vehicle control unit 110 generates the driving environment information corresponding to the second amplified vehicle parameter PAR2-X, and provides the driving environment information to the user of the vehicle 10. Since the second amplified vehicle parameter PAR2-X is larger than the second vehicle parameter PAR2 in the normal simulation mode, the user of the vehicle 10 can more easily experience that the virtual mobility is simulated.

On the other hand, the first amplified vehicle parameter PAR1-X is not necessarily used as it is in the first simulation process even in the sensation amplification mode. In order to suppress the driving force becoming unnecessarily large in the first simulation process, the vehicle control unit 110 may perform the first simulation process using the first suppressed vehicle parameter PAR1-Y smaller than the first amplified vehicle parameter PAR1-X.

In the example illustrated in FIG. 5, the vehicle control unit 110 further includes a suppression unit 150. The suppression unit 150 acquires the first amplified vehicle parameter PAR1-X calculated by the simulation parameter calculation unit 140. The suppression unit 150 sets a first suppressed vehicle parameter PAR1-Y smaller than the first amplified vehicle parameter PAR1-X based on the first amplified vehicle parameter PAR1-X. For example, the suppression unit 150 calculates the first suppressed vehicle parameter PAR1-Y by multiplying the first amplified vehicle parameter PAR1-X by the correction coefficient Y. Here, the correction coefficient Y is a real number smaller than 1 (Y<1). The correction factor Y may be set such that the first suppressed vehicle parameter PAR1-Y is equal to the first vehicle parameter PAR1 in the normal simulation mode. The correction coefficient Y may be an inverse of the correction coefficient X (Y=1/X).

In the normal simulation mode, the suppression unit 150 outputs the first vehicle parameter PAR1 calculated by the simulation parameter calculation unit 140 as it is. This is equivalent to the case where the correction coefficient Y=1.

The selector 160 (arbitration unit) selects the first suppressed vehicle parameter PAR1-Y output from the suppression unit 150, and outputs the first suppressed vehicle parameter PAR1-Y to the motor control unit 170. The motor control unit 170 controls the electric motor 70 in accordance with the first suppressed vehicle parameter PAR1-Y.

As described above, in the sensation amplification mode, the vehicle control unit 110 may perform the first simulation process on the basis of the first suppressed vehicle parameter PAR1-Y smaller than the first amplified vehicle parameter PAR1-X. That is, the vehicle control unit 110 may simulate the driving property of the virtual mobility in accordance with the first suppressed vehicle parameter PAR1-Y smaller than the first amplified vehicle parameter PAR1-X. This suppresses the driving force becoming unnecessarily large, and thus safety is ensured.

Note that the first amplified vehicle parameter PAR1-X itself may be used to simulate an event-change such as a shift-shock. Alternatively, a correction coefficient Y that is relatively close to 1 may be used to simulate an event variation such as a shift shock. This makes it easier to experience event fluctuations such as shift shocks more remarkably.

### 4. High Speed Driving

The sensation amplification mode is particularly effective in low-speed and low-load running in which simulations of virtual mobility are not easily transmitted to the user. On the other hand, during high-speed and high-load driving, the user can easily experience simulations of virtual mobility. Therefore, the effect of the sensation amplification mode may be suppressed during high-speed and high-load running.

For example, a predetermined upper limit value OPE-LIM is set in the operation input value OPE and the amplified operation input value OPE-X input to the simulation parameter calculation unit 140. As described above, the amplification unit 130 multiplies the operation input value OPE by the correction coefficient X (>1). At this time, when the value obtained by multiplying the operation input value OPE by the correction coefficient X exceeds the predetermined upper limit value OPE-LIM, the amplification unit 130 sets the amplified operation input value OPE-X to the predetermined upper limit value OPE-LIM. This reduces the difference between the sensation amplification mode and the normal simulation mode during high-speed and high-load running. That is, the effect of the sensation amplification mode is suppressed during high-speed and high-load running. On the other hand, the sensation amplification mode effectively operates during low-speed and low-load running.

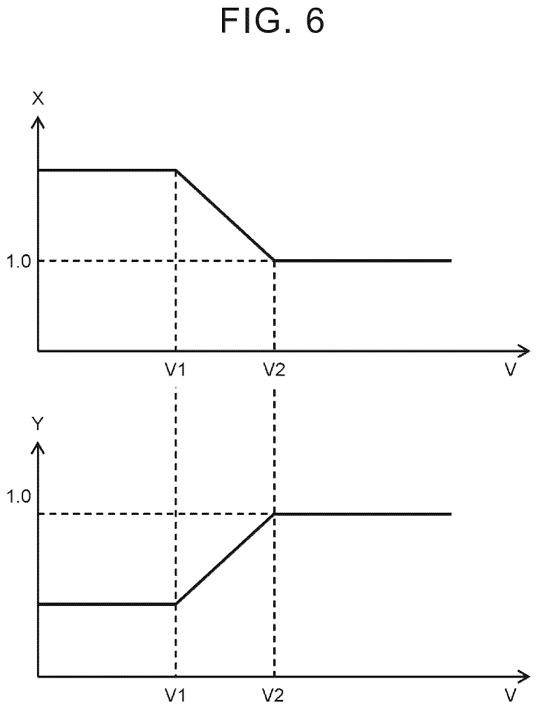

FIG. 6 is a conceptual diagram for explaining a modification. The horizontal axis represents the vehicle speed V, and the vertical axis represents the correction coefficients X and Y. When the vehicle speed V is equal to or less than the first speed V1, the correction coefficient X is greater than 1 and the correction coefficient Y is less than 1. When the vehicle speed V exceeds the first speed V1, the correction coefficient X gradually decreases and gradually approaches 1. On the other hand, when the vehicle speed V exceeds the first speed V1, the correcting factor Y gradually increases and gradually approaches 1. When the vehicle speed V becomes a second speed V2 higher than the first speed V1, the correction coefficients X and Y are both 1. As a result, the sensation amplification mode effectively operates during low-speed and low-load running, while the effect of the sensation amplification mode is suppressed during high-speed and high-load running.

What is claimed is:

1. A vehicle control system to be applied to a vehicle including an electric motor as a drive source, the vehicle control system comprising one or more processors configured to execute a virtual mobility simulation process of simulating virtual mobility in the vehicle, wherein
the one or more processors are configured to, in a sensation amplification mode:
acquire an operation input value corresponding to a driving operation by a driver of the vehicle;
set an amplified operation input value based on the operation input value, the amplified operation input value being larger than the operation input value;
calculate an amplified vehicle parameter for the virtual mobility simulation process by inputting the amplified operation input value to a model of the virtual mobility; and
execute the virtual mobility simulation process based on the amplified vehicle parameter.

2. The vehicle control system according to claim 1, wherein:
the virtual mobility simulation process includes a second simulation process of providing a user of the vehicle with driving environment information including at least one of sound and state information of the virtual mobility;
the amplified vehicle parameter includes a second amplified vehicle parameter for the second simulation process; and
the one or more processors are configured to, in the sensation amplification mode, generate the driving environment information corresponding to the second amplified vehicle parameter.

3. The vehicle control system according to claim 2, wherein:
the virtual mobility simulation process further includes a first simulation process of controlling the electric motor so as to simulate a driving characteristic of the virtual mobility;
the amplified vehicle parameter includes a first amplified vehicle parameter for the first simulation process; and
the one or more processors are configured to, in the sensation amplification mode, simulate the driving characteristic of the virtual mobility in accordance with a first suppressed vehicle parameter that is smaller than the first amplified vehicle parameter.

4. The vehicle control system according to claim 1, wherein:
a predetermined upper limit value is set for the operation input value; and
the one or more processors are further configured to
calculate the amplified operation input value by multiplying the operation input value by a coefficient that is larger than 1, and
when a value obtained by multiplying the operation input value by the coefficient exceeds the predetermined upper limit value, set the amplified operation input value to the predetermined upper limit value.

5. The vehicle control system according to claim 1, wherein the one or more processors are configured to, in a normal simulation mode:
calculate a vehicle parameter for the virtual mobility simulation process by inputting the operation input value to the model of the virtual mobility; and
execute the virtual mobility simulation process based on the vehicle parameter.
